(19) United States
(12) Patent Application Publication
(10) Pub. No.: US 2006/0002295 A1
(43) Pub. Date: Jan. 5, 2006

(54) Suppression of disturbances, caused by burst-like changes of the data rate, during synchronous radio transmission

(76) Inventors: Frank Hurtgen, Dusseldorf (DE); Peter Ascheuer, Dusseldorf (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/159,528

(22) Filed: Jun. 23, 2005

(30) Foreign Application Priority Data
Jun. 24, 2004 (DE) 10 2004 030 631.1

(51) Int. Cl. H04L 12/28

(52) U.S. Cl. 370/229; 370/412; 370/428

(57) ABSTRACT

In a receiving device (1) and method for reception of data packets by radio, having a memory (4), values derived from the values of received data packets are entered and values are emitted for further processing from it. The device comprises a regulating unit (6) for regulating the filling level of the memory (4) at a nominal filling level, with the regulating unit (6) controlling the number of values entered in the memory (4) per received data packet as a function of the filling level.

### CROSS-REFERENCE TO RELATED APPLICATION

This application claims priority from German Patent Application No. 10 2004 030 631.1, which was filed on Jun. 24, 2004, and is incorporated herein by reference in its entirety.

### TECHNICAL FIELD

The invention relates to a receiving device and a transmitting device for radio transmission of data packets, with the receiving device and the transmitting device having special apparatuses for the suppression of disturbances which are caused by burst-like changes in the data rate during synchronous transmission. The invention also relates to corresponding methods.

### BACKGROUND

Synchronous data is transmitted in packets in cordless data transmission systems, such as Bluetooth systems. Different data packet types with different lengths can be used for synchronous transmission at a specific data rate. The expression synchronous transmission of data packets means data transmission in which the data packets are transmitted at a constant data rate and with a predetermined data packet type, periodically. The intervals between the transmission of successive data packets are of equal magnitude, subject to the secondary conditions mentioned above.

During a synchronous transmission, the transmission of a data packet is characterized by the time domain, by a synchronous point in time. For example, the synchronous point in time may be the point in time at which the transmission of the data packet starts. The synchronous point in time has the same periodicity as the synchronous transmission itself.

The data packet type, that is to say the length of the data packets, may also be changed during the connection delay time. If the data rate is constant, for example 64 kBit/s in the Bluetooth Standard, a change in the data packet type results in a change in the frequency with which the data packets are transmitted. A shorter data packet length results in more data packets being transmitted, and a longer data packet length results in fewer data packets being transmitted during a specific time interval.

Furthermore, a change in the data packet type during an existing radio link results in a brief increase or decrease in the data rate. Increase or decrease in the data rate such as this is not deterministic in systems that are based on the Bluetooth Standard, since the choice of the synchronous point in time is arbitrary. Thus, if no special measures are taken, a change in the data packet type during synchronous data transmission results in a burst-like disturbance which, when the data packets are emitted directly via a synchronous medium, generally results in undesirable effects, such as a loud click during speech reproduction.

A similar effect occurs when the synchronous point in time at which the data packet is transmitted must be redefined, and thus changes, during the connection delay time. This is the situation in Bluetooth systems when a synchronous connection in a clock master role and another synchronous connection in a clock slave role occur at the same time in one appliance (scatternet). If the synchronous points in time for the two connections were not redefined, then the clock drift between the master and the slave would result in the synchronous points in time drifting with respect to one another during the connection delay time. The redefining of the synchronous points in time is in turn equivalent to burst-like disturbances in the data rates.

In data transmission systems which are based on the Bluetooth Standard 1.1, only data packet types each having 10, 20 or 30 values (samples) are permitted. If the data packet type is changed during the connection delay time, only a maximum of 20 values are in consequence destroyed. Furthermore, a change in the data packet type in the Bluetooth Standard 1.1 must explicitly be initiated externally, and is thus quite rare. Since the effects of a change in the data packet type in the case of the Bluetooth Standard 1.1 are not serious, the disturbances which are caused by a change in the data packet type have generally been tolerated in systems based on this Standard.

The introduction of the Bluetooth Standard 1.2 has made it possible for a data packet to contain up to 180 values. Furthermore, data packet type changes are now no longer initiated manually but are produced automatically. For example, a change in the data packet type is forced to occur by dynamic matching to the scenario in use, such as the connection or disconnection of connections. In consequence, a data packet type change occurs more frequently in the Bluetooth Standard 1.2 than was the case in the Bluetooth Standard 1.1. Furthermore, the possible errors in the scatternet scenario as described above are far more critical, because the long data packets mean that long pauses are possible between the transmissions of individual data packets, so that the number of possible synchronous points in time is also correspondingly large. The effects that result from this are accordingly considerably more serious than in the Bluetooth Standard 1.1.

### SUMMARY

One object of the invention is therefore to provide both a receiving device and a transmitting device by means of which the disturbances which are caused by a burst-like change in the data rate are reduced. A further aim is to specify corresponding methods.

The object on which the invention is based is achieved by a receiving device for reception of data packets by radio, comprising a buffer store in which values derived from the values of received data packets are entered and from which values are emitted for further processing, and a regulating unit for regulating the filling level of the buffer store at a predetermined nominal filling level or in a predetermined nominal filling level range, with the regulating unit being designed such that it controls the number of values entered per received data packet in the buffer store as a function of the filling level of the buffer store.

The device may further comprise a detector unit for determination of the filling level of the buffer store, with the detector unit being designed in particular such that it determines the filling level of the buffer store before entering in the buffer store values which are derived from the values of a received data packet. The device may further comprise a controllable input unit for entering in the buffer store the values derived from the values in the received data packets, with the input unit being controlled in particular by the regulating unit in such a way that, when there is a need for regulation, the number of values entered in the buffer store by the input unit per received data packet is greater than or less than the number of values in the received data packet. The input unit can be designed such that, when there is a regulation requirement for entering values in the buffer store, it omits or repeats at least one value in the received data packet, or the input unit can be designed such that, when there is a regulation requirement, it produces the values entered in the buffer store on the basis of interpolation of the values in the received data packet. The radio transmission of the data packets can be a synchronous transmission, at least during specific time periods, and/or a constant number of values can be emitted from the buffer store in predetermined time periods. The buffer store can be formed by a ring buffer. The radio transmission of the data packets can be based on the Bluetooth Standard.

The object can also be achieved by a transmitting device for transmission of data packets by radio, comprising a buffer store in which values to be transmitted are entered and from which values for the formation of a data packet to be transmitted by radio are emitted, and a regulating unit for regulating the filling level of the buffer store at a predetermined nominal filling level or in a predetermined nominal filling level range, with the regulating unit being designed such that it controls the number of values emitted from the buffer store per data packet to be transmitted, as a function of the filling level of the buffer store.

The transmitting device may further comprise a detector unit for the determination of the filling level of the buffer store, with the detector unit being designed in particular such that it determines the filling level of the buffer store before the values are emitted from the buffer store. The device may further comprise a controllable output unit for emitting values from the buffer store and for forming a data packet to be transmitted from the emitted values, with the output unit being controlled in particular by the regulating unit in such a way that it emits from the buffer store at least one value more or less than the number of values in the data packet to be transmitted, per data packet to be transmitted, when there is a regulation requirement. The output unit can be designed such that, when there is a regulation requirement during the formation of a data packet, it omits or repeats at least one emitted value from the values which are emitted from the buffer store, or the output unit can be designed such that, when there is a regulation requirement, it produces the values which are assembled to form a data packet on the basis of interpolation of the values emitted from the buffer store. The radio transmission of the data packets can be a synchronous transmission, at least during specific time periods, and/or a constant number of values can be entered in the buffer store in predetermined time periods. The buffer store can be formed by a ring buffer. The radio transmission of the data packets can be based on the Bluetooth Standard.

The object can be also achieved by a method for reception of data packets by radio, comprising the steps of entering values which are derived from the values of received data packets in a buffer store and values are emitted from the buffer store for further processing, wherein the filling level of the buffer store being regulated at a predetermined nominal filling level or in a predetermined nominal filling level range such that the number of values which are entered in the buffer store per received data packet is controlled as a function of the filling level of the buffer store.

The filling level of the buffer store can be determined before entering in the buffer store values which are derived from the values of a received data packet. When there is a regulation requirement, the number of values entered in the buffer store per received data packet can be greater than or less than the number of values in the received data packet. When there is a regulation requirement for entering values in the buffer store, at least one value in the received data packet can be omitted or repeated, or when there is a regulation requirement, the values which are entered in the buffer store can be produced on the basis of interpolation of the values in the received data packet. The radio transmission of the data packets can be a synchronous transmission, at least during specific time periods, and/or a constant number of values can be emitted from the buffer store in predetermined time periods. The data packets can be transmitted in accordance with the Bluetooth Standard.

The object can also be achieved by a method for transmission of data packets by radio, comprising the steps of entering values to be transmitted in a buffer store, and emitting values for formation of a data packet to be transmitted by radio from the buffer store, wherein the filling level of the buffer store being regulated at a predetermined nominal filling level or in a predetermined nominal filling level range such that the number of values emitted from the buffer store per data packet to be transmitted is controlled as a function of the filling level of the buffer store.

The filling level of the buffer store can be determined before emitting values for the formation of a data packet from the buffer store. When there is a regulation requirement per data packet to be transmitted, at least one value more or less than the data packet to be transmitted may have values is emitted from the buffer store. When there is a regulation requirement for the formation of a data packet from the values emitted from the buffer store, at least one emitted value can be omitted or repeated, or when there is a regulation requirement, the values which are combined to form a data packet can be produced on the basis of interpolation of the values emitted from the buffer store. The radio transmission of the data packets can be a synchronous transmission, at least during specific time periods, and/or a constant number of values can be entered in the buffer store in predetermined time periods. The data packets can be transmitted in accordance with the Bluetooth Standard.

The receiving device according to the invention is used for reception of data packets by radio. The receiving device according to the invention has a buffer store and a regulating unit.

A first major idea of the invention is for the received data packets to be temporarily stored in a buffer store. This means that briefly increased or reduced data rates, which are caused, for example, by a change in the data packet type or by redefinition of the synchronous point in time, are first of all initially buffered, since the data can still be emitted from the buffer store at a constant data rate so that burst-like disturbances are not passed on to downstream processing units.

However, it should be noted that the filling level of the buffer store changes whenever the data rate is subject to a burst-like increase or decrease. Furthermore, the filling level of the buffer store can be influenced by other factors, such as fluctuations in the software processing time or clock drift effects. Since the size of the buffer store is limited, the described effects can lead to the buffer store overflowing or becoming empty after a certain time. Overflowing would mean the loss of those data packets which could no longer be written to the buffer store. Emptying of the buffer store would lead to disturbances in the downstream processing units, since no values would be available to these processing units for processing at some times.

Accordingly, further measures must be taken in order to keep fluctuations in the filling level of the buffer store as small as possible. A second major idea of the invention is thus to regulate the filling level of the buffer store such that the filling level is ideally in the vicinity of a predetermined nominal filling level, or in a predetermined nominal filling level range. The regulation process is carried out by the regulating unit which controls the number of values entered per received data packet in the buffer store as a function of the filling level of the buffer store. When a data packet is received, consequently, the current filling level of the buffer store determines how many values are written to the buffer store. Depending on the filling level, all the values of the received data packet can be written to the buffer store, or more or less values than the number of values in the data packet are written to the buffer store. Since, furthermore, values for further processing are also emitted from the buffer store, the regulation of the filling level of the buffer store in the end means that overflowing and emptying cannot occur, with the consequences described above. In fact, it is desirable to always aim for a filling level which is in the vicinity of the nominal filling level or in the nominal filling level range.

As has already been explained above, it is not necessary to write all of the values in a received data packet to the buffer store. Furthermore, the values which are written to the buffer store also need not necessarily represent a subset of the values in the received data packet. All that is necessary is for it to be possible to derive the values that are entered in the buffer store from the values in the received data packet. This opens up various options for the user as to how he can match the number of values entered in the buffer store to the filling level of the buffer store as well as possible.

Since, according to the invention, the data packets are not necessarily entered in the buffer store in the form in which they were received, this results in disturbances in the data stream. However, these disturbances are relatively minor in comparison to the disturbances caused by burst-like changes in the data rate in conventional receiving devices. This is because a burst-like disturbance in conventional receiving devices can result in the omission of an entire burst.

A detector unit is preferably provided in order to check the filling level of the buffer store. The detector unit determines the filling level of the buffer store in particular when a data packet occurs whose values are intended to be entered in the buffer store. The filling level is advantageously checked when each data packet is entered.

Furthermore, the receiving device according to the invention preferably has an input unit, which is controlled by the regulating unit. The object of the input unit is to enter values in the buffer store. These values must be based on the values of received data packets. In particular, the input unit is controlled by the regulating unit such that, when a regulation requirement per received data packet occurs, the input unit enters at least one value more or less than the number of values in the received data packet in the buffer store. A regulation requirement occurs when the buffer store is not at the predetermined nominal filling level, or its filling level is not in the predetermined nominal filling level range.

Two advantageous options are available in order to reduce or to increase the number of values in a received data packet. According to a first option, at least one value of the values in a data packet is omitted, or at least one value is repeated. This option represents a very low-complexity measure for regulating the filling level of the buffer store in the desired direction. However, this measure has the disadvantage that a disturbance is inserted into the data stream. In comparison to the omission of an entire burst, as is possible in conventional receiving devices, the disturbance which is inserted into the data stream is, however, relatively minor.

A second option is not only to omit or to add a value when there is a regulation requirement, but also to interpolate the values in the received data packet. This measure is relatively complex, but it keeps the disturbance that is inserted into the data stream as small as possible. The input unit may contain an interpolator, in order to carry out the interpolation process.

The invention has a particularly advantageous effect when the radio transmission is based on a synchronous transmission, at least during specific time periods. For example, the data packet type must not change during these time periods. The time periods that have been mentioned are used according to the invention to equalize the filling level of the buffer store when there is a regulation requirement. A regulation requirement may result from brief changes in the data rate. Such data rate peaks and troughs occur between the time periods that have been mentioned.

Furthermore, it is preferably possible to provide for values to be emitted from the buffer store at a constant data rate, on average. The rate at which the values are emitted from the buffer store is, for example, governed by the processing speed of the downstream processing units.

The buffer store is preferably formed by a ring buffer.

Furthermore, one particularly preferred refinement of the invention provides for the data packets to be transmitted in accordance with the Bluetooth Standard.

The transmitting device according to the invention for transmission of data packets by radio is based on the same principle as the receiving device according to the invention. In consequence, the transmitting device according to the invention has a buffer store and a regulating unit.

Values to be transmitted and which have been produced by upstream units are entered in the buffer store. The buffer store emits values which are then used for the formation of a data packet to be transmitted by radio.

The regulating unit is used for regulating the filling level of the buffer store at a predetermined nominal filling level or in a predetermined nominal filling level range. For this purpose, the regulating unit controls the number of values emitted from the buffer store per data packet to be transmitted, as a function of the filling level of the buffer store.

The major advantage of the transmitting device according to the invention is that the disturbances in the event of a change in the data packet type and in the event of redefinition of the synchronous point in time are minimized in comparison to conventional transmitting devices. This is achieved analogously to the advantages stated above in conjunction with the receiving device according to the invention.

The transmitting device according to the invention may have advantageous refinements and developments which correspond to the advantageous refinements and developments, as described above, of the receiving device according to the invention.

### BRIEF DESCRIPTION OF THE DRAWINGS

The invention will be explained in more detail in the following text with reference, by way of example, to the drawings, in which:

FIG. 1A shows a schematic illustration of the transmission of data packets by radio with a data rate peak;

FIG. 1B shows a schematic illustration of the transmission of data packets by radio with a data rate trough;

FIG. 2 shows a block diagram of a receiving device 1 as an exemplary embodiment of the receiving device according to the invention;

FIG. 3A shows a schematic illustration of the method of operation of the receiving device 1 as shown in FIG. 2, when a change takes place from an EV5 data packet type to an EV3 data packet type;

FIG. 3B shows a schematic illustration of the method of operation of the receiving device 1 as shown in FIG. 2, when a change takes place from an EV3 data packet type to an EV5 data packet type; and

FIG. 4 shows a block diagram of a transmitting device 50 as an exemplary embodiment of the transmitting device according to the invention.

### DETAILED DESCRIPTION

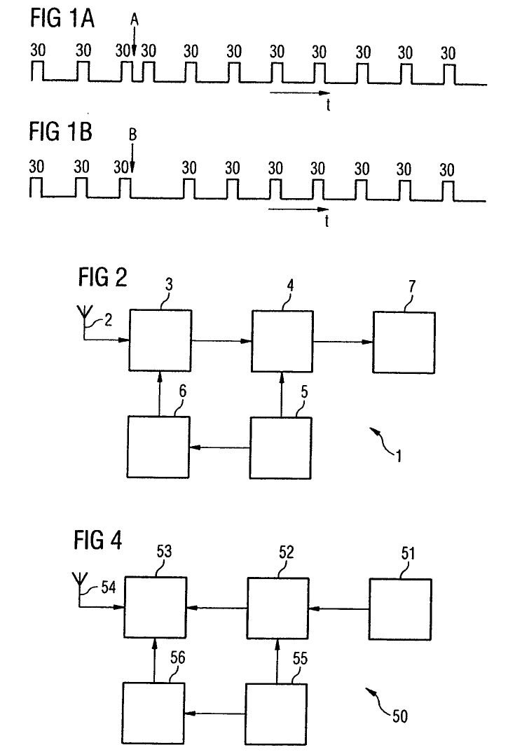

The transmissions of data packets via an air interface are illustrated schematically in FIGS. 1A and 1B. In this case, data packets each having a length of 30 values are transmitted during the connection delay time. The synchronous points in time for the transmission of the data packets are in each case redefined at the points in time which are annotated with the letters A and B in FIGS. 1A and 1B. The redefinition of the synchronous points in time means that the respective time interval which follows the redefinition of the synchronous point in time and in which no data packets are transmitted is not of the normal length. In the situation illustrated in FIG. 1A, the said interval is shortened by the recalculation of the synchronous point in time, while the corresponding interval in FIG. 1B is lengthened. In the first-mentioned case, this leads to a brief data rate peak, and in the last-mentioned case it leads to a data rate trough in the meantime.

FIG. 2 shows the block diagram of a receiving device 1 as an exemplary embodiment of the receiving device according to the invention. The receiving device 1 is designed to receive data packets via an antenna 2. In the present case, the data transmission is based on the Bluetooth Standard.

Received data packets are passed, possibly after pre-processing, to an input unit 3 which is designed to enter at least some of the values in the received data packets into a downstream ring buffer 4.

Furthermore, the receiving device 1 contains a detector unit 5 as well as a regulating unit 6. The detector unit 5 determines the filling level of the ring buffer 4, and the determined value is signalled to the regulating unit 6. The regulating unit 6 uses the filling level signalled to it to determine how many values in a received data packet are entered in the ring buffer 4. This determination process is carried out as a function of a predetermined nominal filling level range. The regulating unit 6 checks whether the current filling level is in the nominal filling level range. Depending on the result of this check, the regulating unit 6 instructs the input unit 3 on how many values from the received data packet are entered in the ring buffer 4.

If the filling level of the ring buffer 4 is in the nominal filling level range, all of the values in the received data packet are entered in the ring buffer 4 by the input unit 3. If the filling level of the ring buffer 4 is above the upper limit of the nominal filling level range, one value from the received data packet is omitted from the input into the ring buffer 4. In the situation where the current filling level is less than the lower limit of the nominal filling level range, one value from the received data packet is repeated for inputting into the ring buffer 4, so that one value more than the values which have actually been received is entered in the ring buffer 4.

Instead of the omission or repetition of a value, it is also possible to provide, in the situation where the current filling level of the ring buffer 4 is not within the nominal filling level, for the values which are intended to be entered in the ring buffer 4 to be determined with the aid of interpolation.

A further variation of the present exemplary embodiment is to restrict the nominal filling level range to just one value.

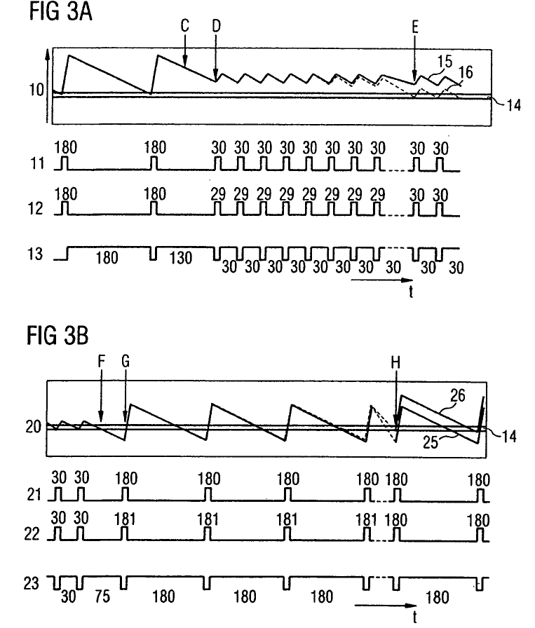

The method of operation of the receiving device 1 as described above is illustrated schematically in FIGS. 3A and 3B.

The filling levels of the ring buffer 4 are in each case plotted against the time t in the rows 10 and 20 in FIGS. 3A and 3B. The rows 11 and 21 show the time periods during which data packets arrive in the receiving device 1. The lines 12 and 22 show the time periods during which values are written to the ring buffer 4. Finally, values are emitted from the ring buffer 4 during the time periods which are marked in the rows 13 and 23.

In addition, FIGS. 3A and 3B show, for each time period, the number of values which have been received by the receiving device 1 during the respective time period or that have been entered in or emitted from the ring buffer 4.

FIG. 3A illustrates the change from an EV5 data packet type to an EV3 data packet type. According to the Bluetooth Standard 1.2, an EV5 data packet has 180 values, while an EV3 data packet comprises 30 values. The change takes place at the point in time identified by the letter C in FIG. 3A. The point in time at which the first EV3 data packet is transmitted is more or less arbitrary. Since the time interval in the example shown in FIG. 3A which passes between completion of the reception of the last EV5 data packet and the arrival of the first EV3 data packet is shorter than the processing time for an EV5 data packet, the data rate measured at the antenna 2 has a brief peak. However, since the data packets are temporarily stored in the ring buffer 4 after their reception and before being passed on to downstream processing units 7, the increased data rate is not passed on to the downstream processing units 7. Instead of this, the brief data rate peak is initially evident in a rise in the filling level of the ring buffer 4, as is shown in the row 10. This filling level is now no longer within a predetermined nominal filling level range 14 and would also no longer reach this filling level—as indicated by the filling level curve annotated with the reference symbol 15, if no additional measures were taken. This is determined by the detector unit 5 at the point in time identified by the letter D, at which the first EV3 data packet is received.

Once the detector unit 5 has detected the increased filling level of the ring buffer 4, the regulating unit 6 instructs the input unit 3 to write only 29 values instead of the received 30 values to the ring buffer 4. However, values are still emitted from the ring buffer 4 to the downstream processing units 7 at the same rate, that is to say 30 values are always emitted from the ring buffer 4 between two successively arriving EV3 data packets. The omission of one value per received data packet is continued until the detector unit 5 finds at a point in time E that the filling level of the ring buffer 4 is within the nominal filling level range. After this, all of the received values are once again written to the ring buffer 4. The regulated filling level curve is annotated with the reference symbol 16 in FIG. 3A.

FIG. 3B shows the converse situation to the example described above, specifically for a change from the EV3 data packet type to the EV5 data packet type. Switching between the two data packet types takes place at a point in time F. This results in a drop in the data rate, since the time period between the reception of the last EV3 data packet and the arrival of the first EV5 data packet is greater than the processing time of an EV3 data packet. In consequence, the temporary storage also results in a drop in the filling level of the ring buffer 4. When the first EV5 data packet is received at a point in time G, the detector unit 5 thus determines a filling level which is below the lower limit of the predetermined nominal filling level range 14.

Without regulation, the balance of the ring buffer 4 would no longer be equalized in this case, either. In fact, the filling level curve 25 as shown in FIG. 3B would result from the described scenario.

However, the regulation according to the invention results in the filling level curve 26 shown in FIG. 3B. In order to achieve this, after the point in time G, 181 values are written to the ring buffer 4 for each received data packet, by in each case repeating one value from a received data packet. The expansion of the data packets written to the ring buffer 5 to 181 values is continued until the detector unit 5 finds, at a point in time H, that the filling level of the ring buffer 4 is once again within the nominal filling level range.

FIG. 4 shows the block diagram of a transmitting device 50 as an exemplary embodiment of the transmitting device according to the invention. The transmitting device 50 is designed to transmit data packets. In the present case, the data transmission is based on the Bluetooth Standard.

Values which are intended to be transmitted are written from the processing units 51 to a ring buffer 52. Values are passed from the ring buffer 52 to an output unit 53, which forms data packets from these values. The data packets are transmitted by an antenna 54.

The transmitting device 50 also contains a detector unit 55 as well as a regulating unit 56. The detector unit 55 determines the filling level of the ring buffer 52. The determined filling level value is signalled to the regulating unit 56. The regulating unit 56 uses the filling level signalled to it to determine how many values will be output from the ring buffer 52 per data packet to be transmitted. This determination process is carried out on the basis of a predetermined nominal filling level range. To this end, the regulating unit 56 checks whether the current filling level is within the nominal filling level range. Depending on the result of this check, the regulating unit 56 instructs the output unit 53 how many values to emit from the ring buffer 52 in order to form a data packet.

The following text is based on the assumption that EV3 data packets, that is to say data packets with 30 values, are intended to be transmitted via the antenna 54.

Provided that the filling level of the ring buffer 52 is within the nominal filling level range, the output unit 3 emits 30, and only 30, values from the ring buffer 52 per data packet to be transmitted. If the filling level of the ring buffer 52 is above the upper limit of the nominal filling level range, the regulating unit 56 causes the output unit 53 to emit 31 values from the ring buffer 52. However, since an EV3 data packet cannot contain more than 30 values, one value that is emitted from the ring buffer 52 is omitted from the formation of the data packet. In the situation where the current filling level is less than the lower limit of the nominal filling level range, only 29 values are emitted from the ring buffer 52. One of the emitted values is repeated during the formation of the data packet. Overall, this procedure leads to the filling level of the ring buffer 52 always being within the nominal filling level range in the medium term.

The transmitting device 50 may have refinements which correspond to the refinements of the transmitting device 1 described above.

We claim:

1. A receiving device for reception of data packets by radio, comprising
a buffer store in which values derived from the values of received data packets are entered and from which values are emitted for further processing, and
a regulating unit for regulating the filling level of the buffer store at a predetermined nominal filling level or in a predetermined nominal filling level range, with the regulating unit being designed such that it controls the number of values entered per received data packet in the buffer store as a function of the filling level of the buffer store.

2. A receiving device according to claim 1, comprising
a detector unit for determination of the filling level of the buffer store, with the detector unit being designed in particular such that it determines the filling level of the buffer store before entering in the buffer store values which are derived from the values of a received data packet.

3. A receiving device according to claim 1, comprising
a controllable input unit for entering in the buffer store the values derived from the values in the received data packets, with the input unit being controlled in particular by the regulating unit in such a way that, when there is a need for regulation, the number of values entered in the buffer store by the input unit per received data packet is greater than or less than the number of values in the received data packet.

4. A receiving device according to claim 3, wherein
the input unit is designed such that, when there is a regulation requirement for entering values in the buffer store, it omits or repeats at least one value in the received data packet, or
the input unit is designed such that, when there is a regulation requirement, it produces the values entered in the buffer store on the basis of interpolation of the values in the received data packet.

5. A receiving device according to claim 1, wherein
the radio transmission of the data packets is a synchronous transmission, at least during specific time periods, and/or
a constant number of values are emitted from the buffer store in predetermined time periods.

6. A receiving device according to claim 1, wherein
the buffer store is formed by a ring buffer.

7. A receiving device according to claim 1, wherein
the radio transmission of the data packets is based on the Bluetooth Standard.

8. A transmitting device for transmission of data packets by radio, comprising:
a buffer store in which values to be transmitted are entered and from which values for the formation of a data packet to be transmitted by radio are emitted, and
a regulating unit for regulating the filling level of the buffer store at a predetermined nominal filling level or in a predetermined nominal filling level range, with the regulating unit being designed such that it controls the number of values emitted from the buffer store per data packet to be transmitted, as a function of the filling level of the buffer store.

9. A transmitting device according to claim 8, comprising
a detector unit for the determination of the filling level of the buffer store, with the detector unit being designed in particular such that it determines the filling level of the buffer store before the values are emitted from the buffer store.

10. A transmitting device according to claim 8, comprising
a controllable output unit for emitting values from the buffer store and for forming a data packet to be transmitted from the emitted values, with the output unit being controlled in particular by the regulating unit in such a way that it emits from the buffer store at least one value more or less than the number of values in the data packet to be transmitted, per data packet to be transmitted, when there is a regulation requirement.

11. A transmitting device according to claim 10, wherein
the output unit is designed such that, when there is a regulation requirement during the formation of a data packet, it omits or repeats at least one emitted value from the values which are emitted from the buffer store, or
the output unit is designed such that, when there is a regulation requirement, it produces the values which are assembled to form a data packet on the basis of interpolation of the values emitted from the buffer store.

12. A transmitting device according to claim 8, wherein
the radio transmission of the data packets is a synchronous transmission, at least during specific time periods, and/or
a constant number of values are entered in the buffer store in predetermined time periods.

13. A transmitting device according to claim 8, wherein
the buffer store is formed by a ring buffer.

14. A transmitting device according to claim 8, wherein
the radio transmission of the data packets is based on the Bluetooth Standard.

15. A Method for reception of data packets by radio, comprising the steps of:
entering values which are derived from the values of received data packets in a buffer store and values are emitted from the buffer store for further processing, wherein
the filling level of the buffer store being regulated at a predetermined nominal filling level or in a predetermined nominal filling level range such that the number of values which are entered in the buffer store per received data packet is controlled as a function of the filling level of the buffer store.

16. A method according to claim 15, wherein
the filling level of the buffer store is determined before entering in the buffer store values which are derived from the values of a received data packet.

17. A method according to claim 15, wherein
when there is a regulation requirement, the number of values entered in the buffer store per received data packet is greater than or less than the number of values in the received data packet.

18. A method according to claim 17, wherein
when there is a regulation requirement for entering values in the buffer store, at least one value in the received data packet is omitted or repeated, or
when there is a regulation requirement, the values which are entered in the buffer store are produced on the basis of interpolation of the values in the received data packet.

19. A method according to claim 15, wherein
the radio transmission of the data packets is a synchronous transmission, at least during specific time periods, and/or
a constant number of values are emitted from the buffer store in predetermined time periods.

20. A method according to claim 15, wherein
the data packets are transmitted in accordance with the Bluetooth Standard.

21. A method for transmission of data packets by radio, comprising the steps of:
entering values to be transmitted in a buffer store, and emitting values for formation of a data packet to be transmitted by radio from the buffer store, wherein
the filling level of the buffer store being regulated at a predetermined nominal filling level or in a predetermined nominal filling level range such that the number of values emitted from the buffer store per data packet to be transmitted is controlled as a function of the filling level of the buffer store.

22. A method according to claim 21, wherein
the filling level of the buffer store is determined before emitting values for the formation of a data packet from the buffer store.

23. A method according to claim 21, wherein
when there is a regulation requirement per data packet to be transmitted, at least one value more or less than the data packet to be transmitted has values is emitted from the buffer store.

24. A method according to claim 23, wherein
when there is a regulation requirement for the formation of a data packet from the values emitted from the buffer store, at least one emitted value is omitted or repeated, or
when there is a regulation requirement, the values which are combined to form a data packet are produced on the basis of interpolation of the values emitted from the buffer store.

25. A method according to claim 21, wherein
the radio transmission of the data packets is a synchronous transmission, at least during specific time periods, and/or
a constant number of values are entered in the buffer store in predetermined time periods.

26. A method according to claim 21, wherein
the data packets are transmitted in accordance with the Bluetooth Standard.
